(19) United States
(12) Patent Application Publication
(10) Pub. No.: US 2004/0244197 A1
(43) Pub. Date: Dec. 9, 2004

(54) Two-piece wheel and method of producing the same

(76) Inventors: Kenzo Takeda, Saitama (JP); Shizuo Kimura, Saitama (JP); Ikuo Kato, Saitama (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/493,309

(22) PCT Filed: Feb. 14, 2003
(86) PCT No.: PCT/JP03/01560

(30) Foreign Application Priority Data
Feb. 15, 2002 (JP) 2002-38012
Feb. 15, 2002 (JP) 2002-38054

(51) Int. Cl. B23P 17/00

(52) U.S. Cl. 29/894.322

(57) ABSTRACT

Both ends of a metal cylindrical member are formed with rectangular cross section normal curls which are doubly bent in the radial direction of the cylindrical member by plastic working. With this, it is possible to form a rim directly from the cylindrical member and to easily produce a two-piece wheel. A barrel of the metal cylindrical member (2) is subjected to drop center portion working. Then, both ends (3) of the cylindrical member (2) are expanded by plastic working, and the expanded ends (3) are formed into normal curls (4) having rectangular cross sections by normal curl working (method 1). Alternatively, the expanded ends (3) are formed into curls (4) having circular cross sections by curl working, and the curls (4) are finished to a normal shape having a rectangular cross section by shaping and precision-enhancing working (method 2). In a rim (8) provided at both ends with the curls (4) having rectangular cross sections, a bead sheet portion (6) is provided with a hump (7), the curls (4) are provided with weep holes (9), a valve hole (11) through which air is charged into a tire is formed in one of drop inclination portions (10), and a disk is mounted in the rim (8), thereby obtaining a two-piece wheel.

### TECHNICAL FIELD

The present invention relates to a two-piece wheel and a method for producing the same.

### BACKGROUND ART

In a buggy wheel, for strengthening both ends of a rim on which a tire is to be mounted, it is known to form the flange portions on both the ends into inward curls having a rectangular cross section by doubly folding both the ends in a radial direction thereof.

For example, Japanese Utility Model Application Laid-open No.S63-56935 shows a method for producing such a wheel. According to this method, a metal plate, such as aluminum alloy is formed into a cup-like shape by deep drawing, a flange on an opening of the cup is inwardly bent by press working so that a rectangular cross section flange provided with a shape and precision for holding a tire, i.e., a normal shaped curl (normal curl) is formed, and then, bottoms of the two cups are joined to each other.

In this wheel, however, since the cup bottoms are superposed to form a disk portion, there is a problem in that the weight of the wheel is increased. Further, since the disk portion becomes a flat plate, there is also a problem in that the disk portion is poor in design. Furthermore, it is difficult to align the centers of the superposed cups.

In view of the problems of the conventional technique, an object of the present invention is to provide a producing method capable of easily producing a two-piece wheel having a disk mounted on an inner side of a rim, in which both ends of a metal cylindrical member are formed into a normal shaped rectangular cross section curl by plastic working and the rim is directly formed from the cylindrical member, and a two-piece wheel.

### DISCLOSURE OF THE INVENTION

To achieve the above object, according to the invention defined in claim 1, there is provided a two-piece wheel comprising a rim having flange portions having rectangular cross sections formed by doubly bending both ends of a metal cylindrical member in a radial direction of the cylindrical member by plastic working, and a disk disposed in the rim perpendicularly to an axis of the rim and having a peripheral edge connected to an inner wall of the rim.

According to the invention defined in claim 2, there is provided a method for producing a two-piece wheel in which a disk is disposed in a rim perpendicularly to an axis of the rim and a peripheral edge of the disk is connected to an inner wall of the rim, the method comprising: a pipe-expansion step for expanding both ends of a cylindrical metal rim material by plastic working, and a rectangular flange portion-forming step for deforming the expanded ends by plastic working and forming flange portions having rectangular cross sections which are doubly bent in a radial direction.

According to the invention, the pipe-expansion step can be carried out by press working, spinning working or roll forming working. The rectangular flange portion-forming step can be carried out by press working or spinning working.

According to the invention defined in claim 5, there is provided a method for producing a two-piece wheel in which a disk is disposed in a rim perpendicularly to an axis of the rim and a peripheral edge of the disk is connected to an inner wall of the rim, the method comprising: a pipe-expansion step for expanding both ends of a cylindrical metal rim material by plastic working, a circular flange portion-forming step for forming the expanded ends into flange portions having circular cross sections in the radial direction by plastic working, and a finishing step for deforming the flange portions having circular cross sections into the flange portions having rectangular cross sections which are doubly bent in the radial direction by plastic working.

According to this invention, the pipe-expansion step can be carried out by press working, spinning working or roll forming working. The circular flange forming step can be carried out by spinning working. The finishing step can be carried out by press working, spinning working or roll forming working.

According to the invention defined in claim 9, there is provided a method for producing a two-piece wheel in which a disk is disposed in a rim perpendicularly to an axis of the rim and a peripheral edge of the disk is connected to an inner wall of the rim, the method comprising: a circular flange portion-forming step for forming both ends of a cylindrical metal rim material into flange portions having circular cross section in a radial direction by plastic working, and a finishing step for deforming the flange portions having circular cross sections into the flange portions having rectangular cross sections which are doubly bent in the radial direction by plastic working.

According to this invention, the circular flange portion-forming step can be carried out by press working, spinning working or roll forming working. The finishing step can be carried out by press working, spinning working or roll forming working.

According to the present invention, the following effects can be obtained.

(1) Since a rim both ends of which have rectangular cross section curl of normal shape (rectangular cross section flange portion which is doubly bent in its radial direction) can directly be formed from a cylindrical member, it becomes easy to produce a two-piece wheel.

(2) Since a wheel which can be obtained is a two-piece wheel in which a disk is mounted on an inner side of the rim, material can be saved as compared with a conventional wheel in which bottoms of two cups are connected to each other, and it is possible to provide a lightweight wheel.

(3) Since the disk is mounted afterward, the design of the wheel can easily be enhanced by using the disk having excellent design.

(4) Since the rim is formed from the cylindrical member, aligning of a center axis of the wheel is easy.

### BRIEF DESCRIPTION OF DRAWINGS

FIG. 1 is an explanatory view showing typical working steps in one embodiment of a method for producing a wheel according to the present invention;

FIG. 2 is a sectional view showing a pipe-expansion working of a cylindrical member in an embodiment 1 of the invention;

FIG. 3 is a sectional view showing an expanded end;

FIG. 4 is a sectional view showing a normal curl working in the embodiment 1;

FIG. 5 is a sectional view showing the continuation of FIG. 4 of the normal curl working;

FIG. 6 is a sectional view showing the continuation of FIG. 5 of the normal curl working;

FIG. 7 is a sectional view of a pipe-expansion working of a cylindrical member of an embodiment 2 of the invention;

FIG. 8 is a sectional view showing a normal curl working of the embodiment 2;

FIG. 9 is a sectional view showing the continuation of FIG. 8 of the normal curl working;

FIG. 10 is a sectional view showing the continuation of FIG. 9 of the normal curl working;

FIG. 11 is a sectional view showing a concurrent working of the pipe expansion of a cylindrical member and a drop center portion;

FIG. 12 is a sectional view showing a curling working of a cylindrical member according to an embodiment 4 of the invention;

FIG. 13 is a sectional view showing a curl precise shaping of the embodiment 4;

FIG. 14 is a sectional view showing the continuation of FIG. 13 of the curl precise shaping;

FIG. 15 is a sectional view of a curl precise shaping of an embodiment 5 of the invention;

FIG. 16 is a view of FIG. 15 as viewed from the right side;

FIG. 17 is a sectional view showing a curl precise shaping in an embodiment 6 of the invention;

FIG. 18 is an explanatory view of typical working steps of the method for producing the wheel according to another embodiment of the invention;

FIG. 19 is a sectional view showing a curl working by a press in an embodiment 7 of the invention;

FIG. 20 is a sectional view showing a curl precise shaping by a press in the embodiment 7;

FIG. 21 is a sectional view showing the continuation of FIG. 20 of the curl precise shaping;

FIG. 22 is a sectional view showing a curl working to which a working of a drop center portion by spinning is added of an embodiment 8 of the invention;

FIG. 23 is a sectional view showing a curl precise shaping by spinning in the embodiment 8;

FIG. 24 is a view of FIG. 23 as viewed from the right side; and

FIG. 25 is a sectional view showing a curl precise shaping by roll forming of an embodiment 9 of the invention.

### BEST MODE FOR CARRYING OUT THE INVENTION

### EMBODIMENT 1

Tests and researches are repeated to obtain wheels having no drawback possessed by a conventional technique in which bottoms of two cups are connected to each other. As a result, it is found that a rim could be produced directly from a cylindrical member by forming rectangular cross section curls on both ends of a metal cylindrical member by plastic working, and the present invention is accomplished based on the findings. According to the present invention, a two-piece wheel in which a disk is mounted on an inner side of a rim is produced.

In one embodiment of the present invention, both ends of a metal cylindrical member, such as 5000 series aluminum alloy are first expanded. Then, the expanded ends are doubly bent in the radial direction by plastic deformation, and thus, rectangular cross section flange portions having shape and precision for holding a tire, i.e., curls having normal shape (normal curls) are formed. The normal curl is obtained by forming a cross section of an inward curl into a rectangular shape. The normal curl has a cross section including a straight portion projecting radially outward from a cylindrical member, an R-portion extending in an axial direction from the straight portion and having small curvature, and a straight portion extending from the R-portion toward the cylindrical member radially inward. Forming methods of the normal curl are broadly divided into the following two methods 1 and 2.

In the method 1, an expanded end (flare) is formed into a normal curl by press working or spinning working, or by both the press working and spinning working (normal curl working, i.e., forming working of the rectangular flange portion). In roll forming working, it is difficult to form a normal shaped curl having a rectangular cross section from the expanded end.

In the method 2, the expanded end is formed into a circular cross section shape by the spinning working (curl working, i.e., circular flange portion forming working), and then, the circular end is formed into a normal shape having a rectangular cross section by the press working, spinning working or roll forming working (curl precise shaping, i.e., finishing working), thereby obtaining the normal curl. In the press working or roll forming working, it is difficult to form a circular cross section curl from the expanded end. The circular cross section curl can be finished into the rectangular cross section by any of the press working, spinning working and roll forming working.

In the present invention, embodiments 1 to 4 use the method 1, and embodiment 5 to 7 use the method 2.

The pipe-expansion working can be carried out by the press working, spinning working or roll forming working. The cylindrical member is first subjected to drop center portion working, and the cylindrical member after the drop center portion working is subjected to the pipe-expansion working. When the pipe-expansion working is carried out by the spinning or roll forming, since the drop center portion working can also be carried out together, it is not always necessary to carry out the drop center portion working before the pipe-expansion working.

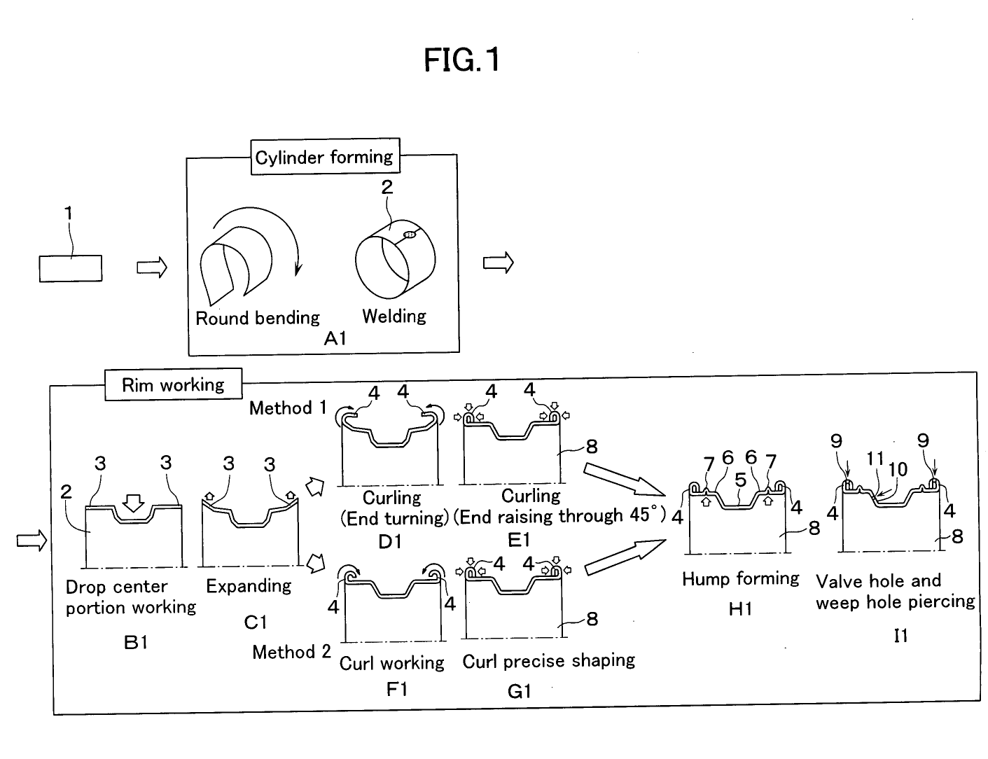

FIG. 1 shows typical working steps in the method for producing a wheel according to the invention.

As shown in FIG. 1, first, a prepared blank material 1 which is a metal member is rounded or wound into a cylindrical shape by a coiler or the like, and ends of the wound blank material 1 in its longitudinal direction are joined to each other by butt welding to form a cylindrical member (rim blank material) 2 (step A1). A drop center portion is formed in the barrel of the cylindrical member by the spinning working or roll forming working (step B1). In this step B1, the drop center portion is formed in the barrel of the cylindrical member 2, and to make it easy to mount a disk which receives a hub to which an axle is mounted after the cylindrical member is formed into the rim, a step (not shown) is formed in the barrel. After the drop center portion working, both ends of the cylindrical member 2 are expanded (step C1).

Next, in the method 1, expanded ends 3 of the cylindrical member 2 are subjected to the normal curl working (rectangular flange portion forming working) to obtain normal shaped curls. In the normal curl working, the expanded ends 3 are inwardly turned to form hook-shaped curls 4 which become narrower (ends turning, step D1), tip ends of the hook-shaped curls 4 are further bent inward, and they are formed into a normal shape having a rectangular cross section, which has shape and precision suitable for holding a tire (45° raising, step E1)

In the method 2, the expanded ends 3 of the cylindrical member 2 are subjected to the curl working (circular flange portion forming step), and then, curl precise shaping (shaping and precision-enhancing; finishing step) is carried out to obtain normal shaped curls. First, the expanded ends 3 are inwardly bent to form the circular cross section curls 4 (step F1), the circular cross section curls 4 are finished, and curls 4 are formed into a normal shape having a rectangular cross section, which has shape and precision suitable for holding a tire (precise shaping, step G1).

In this manner, the rim 8 provided at both of its ends with rectangular cross section inward curls 4 is obtained. Then, the rim 8 is subjected to finishing treatment. First, bead sheet portion 6 on both the sides of the drop center portion 5 of the barrel of the rim 8 are provided with humps 7 by spinning working or roll forming working (step H1). Then, weep holes 9 are formed in the curls 4 of the rim 8, and a valve hole 11 through which air is charged into a tire which is to be mounted to the wheel is formed in one of drop inclination portions 10 between the center drop portion 5 and the bead sheet portion 6 (step I1), and the finishing of the rim 8 is completed. Thereafter, a disk which receives an axle mounting hub is mounted in the cylindrical portion of the rim 8, and the two-piece wheel can be obtained.

In the embodiment 1, after the drop center portion working, the cylindrical member 2 is expanded by press, and then, the normal curl working of the method 1 is carried out by press.

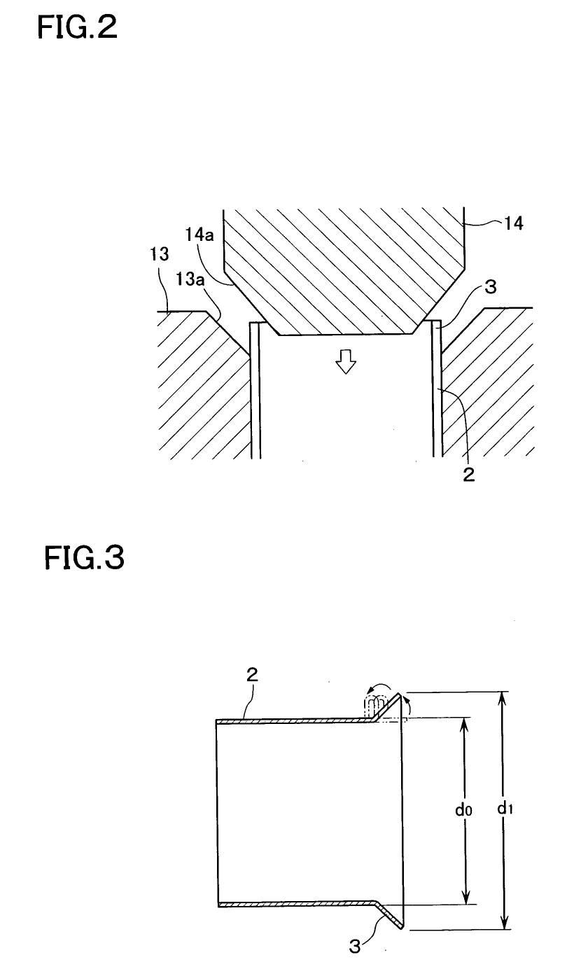

First, as shown in FIG. 2, the cylindrical member 2 after the drop center portion working is mounted on a cylindrical die 13 which is set to a press machine, the end 3 of the cylindrical member 2 is pressed by a punch 14 having a truncated portion 14a. The truncated cone portion 14a has the same taper angle as that of a reversely tapered surface 13a of the die 13. With this operation, the ends 3 are outwardly expanded.

A pipe-expansion ratio η of the end 3 of the cylindrical member 2, i.e., if an outer diameter of the end 3 of the cylindrical member 2 before expansion is defined as “d0” and the outer diameter after the expansion is defined as “d1”, η=(d1−d0)/d1 must equal to or lower than breaking elongation of material of the cylindrical member 2. When the curl is formed on the end, a surface which has been an inner side surface of the end before working becomes an outer side surface by forming the curl and thus, the curvature is inverted. However, if the pipe-expansion ratio exceeds the breaking elongation of the material, crack (edge crack in the radial direction) is prone to be generated in the end if the curl is formed. On the other hand, if the pipe-expansion ratio is smaller, when the curl is formed, the change of the reverse curvature becomes great, and local buckling is prone to be generated. If the pipe-expansion ratio is set smaller than the breaking elongation by 2 to 3%, the end can be expanded without generating edge crack in the end, and since the outward deformation of the curl thereafter is small, the working is easy. Since the pipe-shrinkage ratio in the end when the end is curled is small, the wrinkling is less prone to be generated, and reduction in thickness of the end is also small.

Not only when the ends are expanded by press, but also when the ends are expanded by roll forming, the requirement of the pipe-expansion ratio is the same. Not only when the method 1 (the rectangular cross section normal curls are formed by press, spinning or roll forming) is employed for forming the curls after expansion, but also when the method 2 (circular cross section curls are formed by spinning, and the curls are finished to the rectangular cross section normal shape by press, spinning or roll forming) is employed, the requirement of the pipe-expansion ratio is the same.

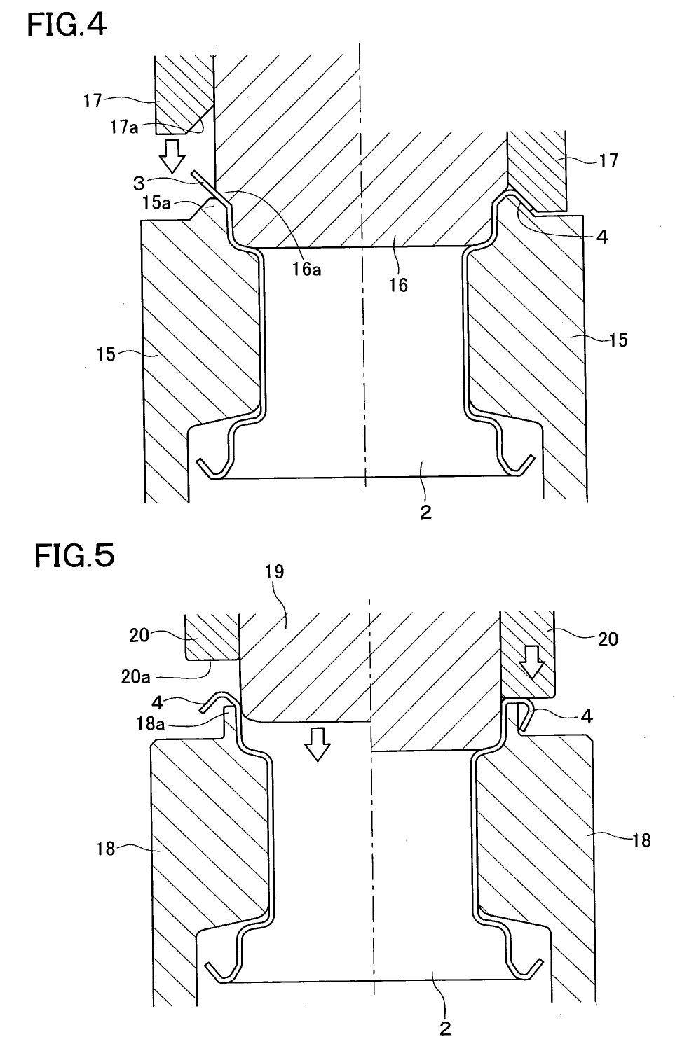

In the embodiment 1, the normal curl working by press working is carried out as shown in FIGS. 4 to 6. First, as shown in FIGS. 4 and 5, the curls are formed by turning the ends.

In FIG. 4, lower dies 15 and 15 of left and right split type dies having projections 15a projecting upward while inclining at the same angle as that of the expanded end 3 of the cylindrical member 2, and an upper die 16 having a tapered surface 16a which inclines at the same angle as the projections 15a are set on the press machine. The cylindrical member 2 is mounted in the lower dies 15 and 15, the upper die 16 holds the cylindrical member 2, base end of the end 3 is held by the inner sides of the projections 15a of the lower dies 15 and the tapered surface 16a of the upper die 16. In this state, the end 3 is pressed by right and left split type punches 17 and 17 having tapered surfaces 17a which incline at the same angle as the outer surface of the projection 15a. The tip end of the end 3 is bent toward the same direction as the base end. Thus, each end 3 is formed into the curl 4 having opened hook-like cross section.

Next, as shown in FIG. 5, the cylindrical member 2 is mounted in lower dies 18 and 18 of split type dies having thin projections 18a whose tip ends have flat surfaces, and the upper die 19 holds the cylindrical member 2. In this state, the hook-shaped curl 4 is pressed by left and right split type punches 20 having flat surfaces 20a. The entire curl 4 is bent inward such that the hook-shaped base end of the curl 4 is square to the barrel of the cylindrical member 2. Thus, each curl 4 is formed into the hook shape whose tip end is narrow (the end turning operation is completed in FIGS. 4 and 5).

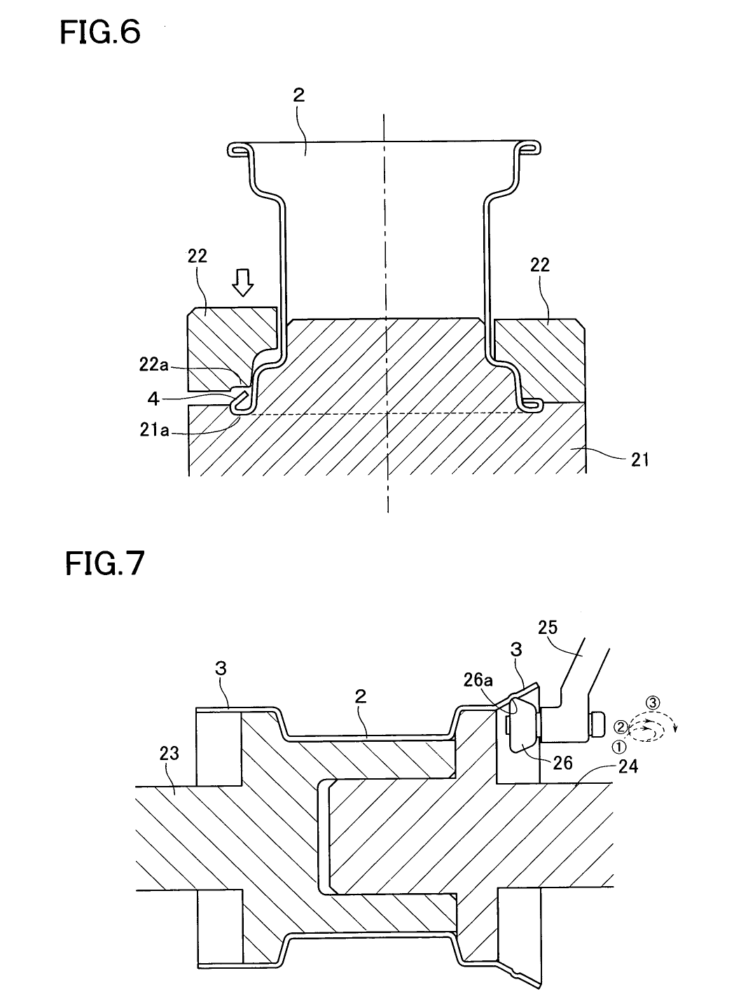

Next, as shown in FIG. 6, the cylindrical member 2 is pressed using a lower die 21 having a shallow recess 21a whose bottom surface is flat and left and right split type punches 22 and 22 having shallow notches 22a whose bottom surfaces are flat. Tip end straight portion of the curl 4 is inclined and bent inward (i.e., raised, raising angle is normally about 45°) such that the tip end is square to the barrel (bead sheet portion), and the tip end straight portion is brought into intimate contact with the cylindrical member 2 and is closed (raising through 45°). With these operations, the curl 4 is formed into the rectangular cross section shape which is doubly bent in the radial direction, i.e., into a normal shape having a rectangular cross section, in which the two straight portions in the radial direction sandwich the R-portion in the axial direction having small curvature. Thus, each curl 4 is provided with the shape and precision suitable for holding the tire.

In the rim 8 provided at both the ends with the rectangular cross section inward normal curls 4, the bead sheet portions 6 on both sides of the drop center portion 5 are provided with the humps 7 by spinning working or roll forming working as shown in FIG. 1 (step H1). The weep holes 9 are formed in the curls 4 of the rim 8. The valve hole 11 through which air is charged into the tire is formed in an inclining portion of one of the drop inclination portions 10 between the drop center portion 5 and the opposite bead sheet portions 6, and the disk is mounted in the cylinder of the rim 8 by welding, thereby producing the two-piece wheel.

The producing method of this embodiment has the above-mentioned configuration, and can exhibit the following effects:

(1) Since a rim both ends of which have rectangular cross section curls of normal shape can be formed directly from a cylindrical member, it becomes easy to produce a two-piece wheel.

(2) Since a wheel which can be obtained is a two-piece wheel in which a disk is disposed perpendicular to an axis of the rim and a peripheral edge of the disk is connected to an inner wall of the rim, material can be saved as compared with a conventional wheel in which bottoms of two cups are connected to each other, and it is possible to provide a lightweight wheel.

(3) Since the disk is mounted afterward, the design of the wheel can easily be enhanced by using the disk having excellent design.

(4) Since the rim is formed from the cylindrical member, the alignment of a center axis of the wheel is easy.

(5) Since both the pipe-expansion working and normal curl working are carried out by press working, the mass productivity of the wheel is high.

Although both the pipe expansion and normal curl working are carried out by the press working in the embodiment 1, the present invention is not limited to this, and normal curl working can be carried out by spinning or roll forming after the ends are expanded by press.

### EMBODIMENT 2

In the embodiment 2, the pipe-expansion working and normal curl working are carried out by spinning as shown in FIGS. 7 to 10 show.

First, as shown in FIG. 7, left and right split type dies 23 and 24 can be fitted into each other in the longitudinal direction. One of the dies 23 and 24 is mounted on a die supporting section of a spinning lathe, and the other die is mounted to a shaft pushing section of the lathe. The cylindrical member 2 is fitted into an outer surface of the die 23, the die 24 is pushed into the die 23 in the axial direction, and the cylindrical member 2 is mounted on the integral dies 23 and 24. Then, the cylindrical member 2 is rotated by rotation of the dies 23 and 24. In this state, a gently inclined reversely conical forming roll 26 mounted on a jig 25 is rotated, and a rounded peripheral edge 26a on a tip end of the forming roll 26 is butted against the end 3 of the cylindrical member 2.

Then, jig 25 controls the movement of the forming roll 26, and the peripheral edge 26a repeatedly pushes the end 3 from inside to outside to draw a ring such that swelling of a ring of the peripheral edge 26a is gradually increased as shown with 1)→2)→3) in FIG. 7, thereby gradually outwardly pushing and spreading the expanded end 3 until desired pipe-expansion ratio is obtained.

The jig 25 can move upward, downward, forward, backward, leftward and rightward by means of a hydraulic cylinder or electric motor screw.

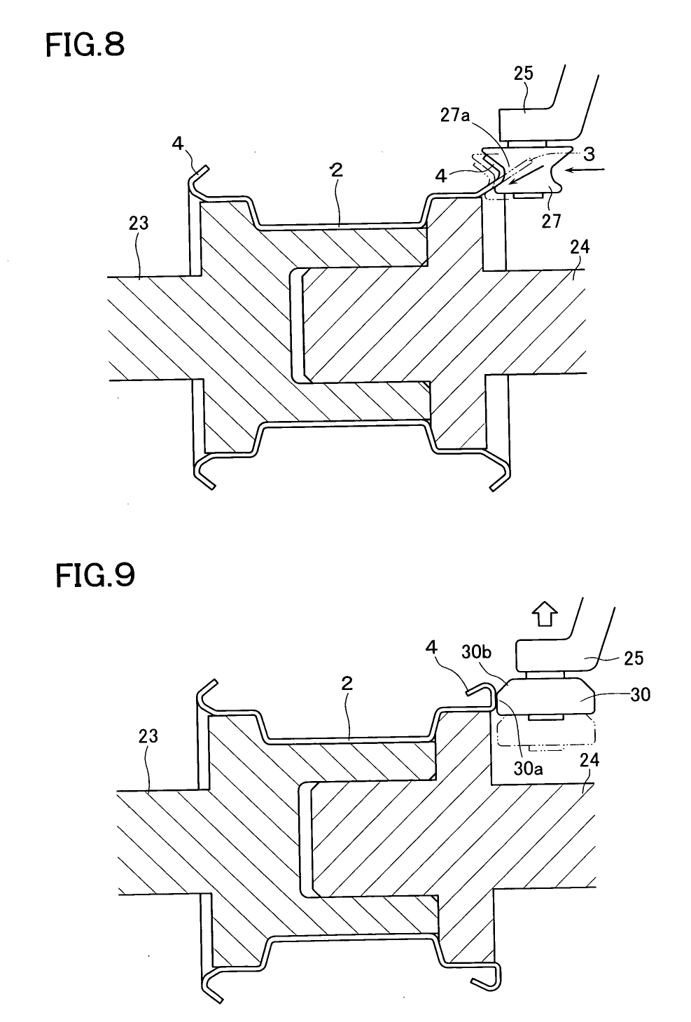

Next, as shown in FIG. 8, a forming roll (spinning top) 27 having a recess 27a whose upper forming surface is long and outwardly spreading is mounted on the jig 25. The forming roll 27 is rotated, the recess 27a is gradually and horizontally pushed against the expanded end 3 of the rotating cylindrical member 2 by operating the jig 25. Then, the recess 27a is gradually pushed against the expanded end 3 diagonally downwardly. With this, the tip end of the expanded end 3 is gradually bent, and the end 3 is formed into the curl 4 having the opened hook-shaped cross section.

Then, as shown in FIG. 9, a forming roll 30 in which an upper portion 30b having a bevel surface is continuously formed on a barrel 30a having a flat surface is mounted on the jig 25. The forming roll 30 is rotated and the upper portion 30b of the forming roll 30 is pushed against the hook-shaped curl 4 of the rotating cylindrical member 2. The forming roll 30 is slowly pulled upward and the barrel 30a is pushed against the hook-shaped curl 4. The entire curl 4 is bent and raised such that the base end of the hook-shape of the curl 4 is square to the barrel of the cylindrical member 2, and thus the curl 4 is formed into the hook-shaped cross section whose tip end is narrowed (FIGS. 8 and 9 show the turning operation of the end).

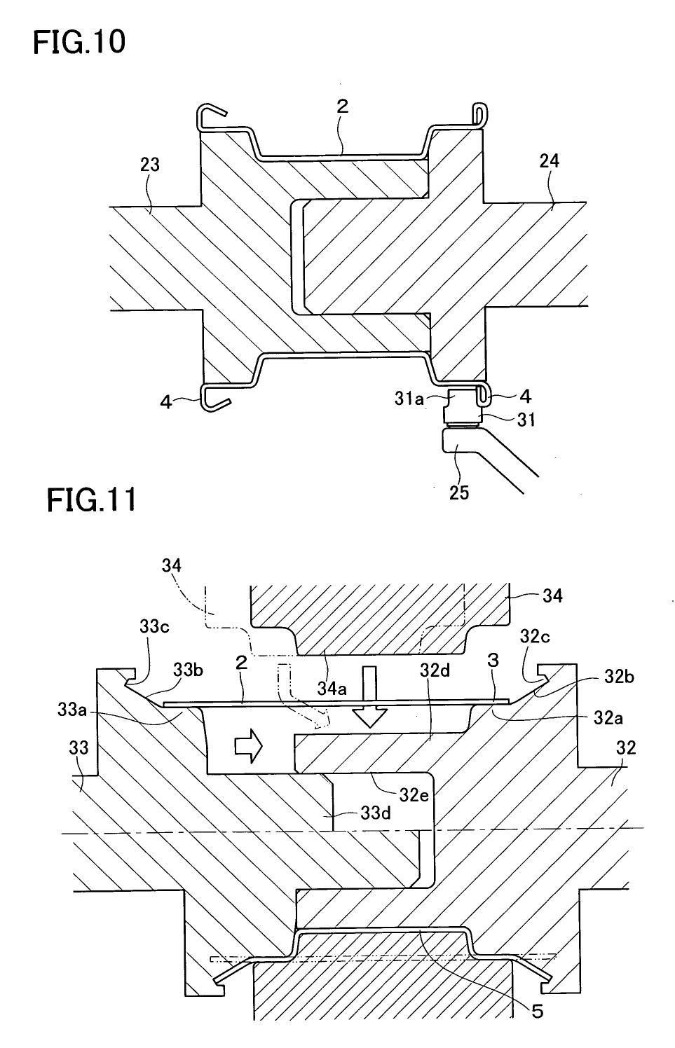

Lastly, as shown in FIG. 10, a diameter-reduced portion 31a of the forming roll 31 mounted on the jig 25 is pushed from inner side in the lateral direction against the side surface of the tip end of the curl 4, the tip end straight portion of the curl 4 is inclined inward so as to be square to the barrel (45° raising), and the tip end straight portion is brought into intimate contact with the cylindrical member 2 and closed. With this, the curl 4 is formed into a normal shape having a rectangular cross section, in which the R-portion is sandwiched by the straight portions, and is provided with the shape and precision suitable for holding the tire.

The rim 8 obtained in this manner is processed in the same manner as the embodiment 1, and the two-piece wheel is produced.

According to this embodiment also, the same effects as those of the embodiment 1 can be obtained. Especially in the second embodiment, since the pipe-expansion working and normal curl working are carried out by spinning, there is a merit that the embodiment is suitable for producing a small number of and various wheels.

Although the normal curl working is carried out by spinning in the embodiment 2, the present invention is not limited to this, and the normal curl working may be carried out by press.

### EMBODIMENT 3

In the embodiment 3, the pipe-expansion working is carried out by roll forming, and drop center portion working is carried out by roll forming simultaneously. FIG. 11 shows the embodiment 3.

As shown in FIG. 11, left and right split type dies 32 and 33 which can be fitted into each other in the longitudinal direction, and a forming roll 34 are prepared. The right die 32 is mounted on a die supporting section of a spinning lathe, and the left die 33 is mounted on a shaft pushing section of the lathe.

The die 32 includes a step portion 32a, a tapered portion 32b which is continuously formed on a tip end of the step portion 32a and which is upwardly inclined, a groove 32c formed in a tip end of the tapered portion 32b, and a parallel portion 32d downwardly extending from a base end of the step portion 32a and continuously formed on the base end of the step portion 32a. A cylindrical recess 32e is formed in the axial central portion of the die 32. The die 33 includes a step portion 33a, a tapered portion 33b which is continuously formed on a tip end of the step portion 33a and which is upwardly inclined, and a small groove 33c formed in a tip end of the tapered portion 33b. The axial central portion of the die 33 is formed as a cylindrical projection 33d which is continuous with a base end of the step 33a. The projection 33d is fitted into the recess 32e of the right die 32.

The forming roll 34 is provided at its surface with a parallel projection 34a. The parallel projection 34a is formed into such a shape that the parallel projection 34a is fitted into a parallel recess comprising the step portion 32a, the parallel portion 32d and the step portion 33a of the die 33 which butts against an end surface of the parallel portion 32d.

One end 3 and the other end 3 of the cylindrical member 2 are mounted on the step portion 32a of the die 32 and the step portion 33a of the die 33, and the cylindrical member 2 is rotated by rotation of the dies 32 and 33. In this state, the die 33 is moved toward the die 32 in the axial direction to shorten a distance between the dies 32 and 33. Concurrently, the forming roll 34 is rotated to move in the radial direction, thereby pushing the barrel of the cylindrical member 2.

With this operation, one and the other ends 3 of the cylindrical member 2 are pushed, spread and expanded along the tapered portions 32b and 33b until the ends 3 abut against the grooves 32c and 33c of the dies 32 and 33. Together with this operation, the barrel of the cylindrical member 2 is deformed in the radial direction by the forming roll 34 and is formed as the drop center portion 5.

To carry out the pipe expansion and the drop center portion working at the same time by spinning, the forming roll 34 may be allowed to move in the radial direction and in the axial direction toward the die 32 as shown with the chain double-dashed line in FIG. 11.

Since the normal curl cannot be formed on the expanded end 3 by roll forming, the normal curl is formed by spinning working as in the embodiment 2.

The rim 8 obtained in this manner is processed in the same manner as the embodiment 1, and the two-piece wheel is produced.

Although the pipe-expansion working and the drop center portion working are carried out at the same time in this embodiment, the drop center portion working may be carried out before the pipe-expansion working.

According to this embodiment also, the same effects as those of the embodiment 1 can be obtained. Although the normal curl working is carried out by spinning working in the embodiment 3, the normal curl working may be carried out by press working.

### EMBODIMENT 4

In the embodiment 4, the ends of the cylindrical member after the drop center portion working are expanded by press working, the cross section hook-shaped curls are formed by press working, and then, the cross section of the curls is formed into rectangular shape, thereby obtaining the normal curls.

The ends are expanded by press working in the same manner as the embodiment 1 as shown in FIG. 2. The cross section hook-shaped curls are formed by press working in the same manner as the embodiment 2, but the curls may be stopped in a state in which the tip ends of the cross section hook-shaped curls 4 are opened as shown in FIG. 4, or the tip ends are pressed and narrowed as shown in FIG. 5. The hook-shaped curl 4 whose tip end is narrowed shown in FIG. 5 is subjected to one step spinning working as shown in FIG. 10, and the hook-shaped curl 4 whose tip end is opened shown in FIG. 4 is subjected two step spinning working as shown in FIGS. 9 and 10, thereby forming the rectangular cross section normal curl.

The rim 8 obtained in this manner is processed in the same manner as the embodiment 1, and the two-piece wheel is produced. According to this embodiment also, the same effects as those of the embodiment 1 can be obtained.

### EMBODIMENT 5

Although the normal curls are basically formed from the expanded ends by the method 1 in the embodiments 1 to 4, the normal curls are formed by the method 2 in the embodiments 5 to 7.

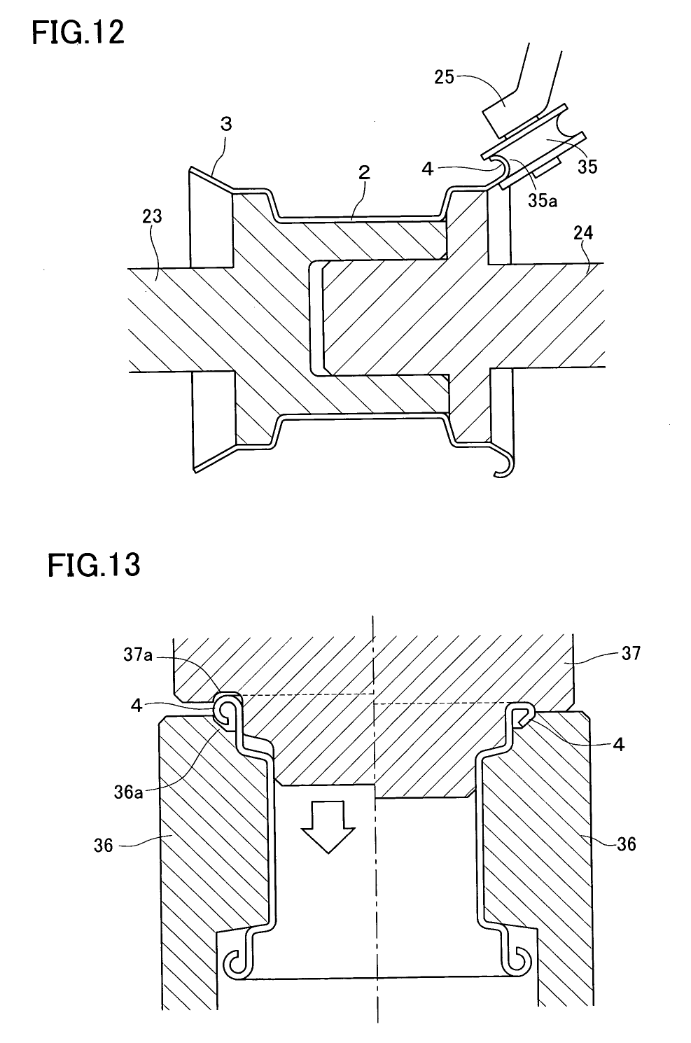

In the embodiment 5, the ends of the cylindrical member after the drop center portion working are expanded by press working, the circular cross section curls are formed by spinning (curl working), and then, the cross section is formed into rectangular shape by press (curl precise shaping), and the normal curls are obtained. Since the pipe expansion by press is described in the embodiment 1, it is omitted here. FIG. 12 shows curl working by spinning.

In FIG. 12, the cylindrical member 2 after the pipe expansion is mounted on split type dies 23 and 24 mounted on the spinning lathe as in the same manner as that shown in FIG. 7, and the cylindrical member 2 is rotated. In this state, a forming roller 35 having a semi-arc recess 35a mounted on the jig 25 is rotated, and the forming roller 35 is allowed to butt against the cylindrical member 2 at an angle slightly greater than the inclination of the expanded end 3. The end 3 is bent along the arc of the recess 35a, and is formed into a circular cross section semi-arc curl 4.

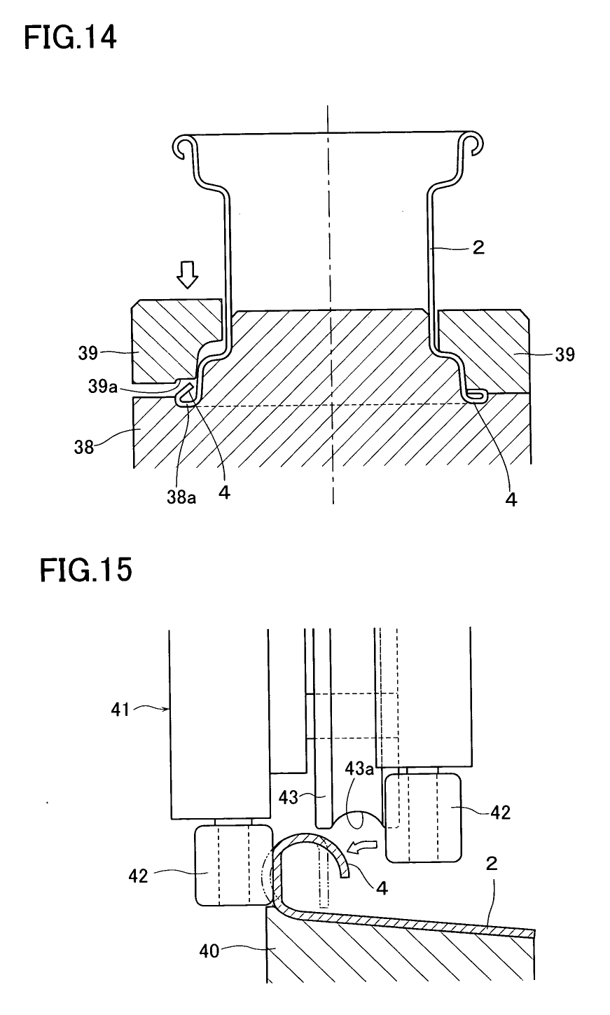

Then, as shown in FIGS. 13 to 14, the curl precise shaping is carried out by press. First, as shown in FIG. 13, left and right split type lower dies 36 and 36 provided with notches 36a having tapered surface, and an upper die 37 having a shallow recess 37a whose bottom surface is flat are used. The circular cross section curl 4 of the end of the cylindrical member 2 is pressed, and upper surface of central portion of the arc of the curl 4 is crushed by the recess 37a of the upper die 37 to form the upper surface flat. Bend of the arc tip end of the curl 4 is straightened and inclined inward by the tapered notches 36a of the lower dies 36.

Then, as shown in FIG. 14, the curl is pressed using a lower dies 38 having a shallow recess 38a whose bottom is flat, and left and right split type punches 39 and 39 having shallow notches 39a whose bottoms are flat. The tip end straight portion of the curl 4 is further inwardly inclined by the notches 39a, the straight portion is brought into intimate contact with the barrel of the cylindrical member 2 and is closed. With these operations, the curl 4 is formed into a normal shape having a rectangular cross section, in which the R-portion is sandwiched by the straight portions, and the curl 4 is provided with the shape and precision suitable for holding the tire.

The rim 8 obtained in this manner is processed in the same manner as the embodiment 1, and the two-piece wheel is produced.

According to the embodiment 5 also, the same effects as those of the embodiment 1 can be obtained.

Although the curl precise shaping is carried out by press in the embodiment 5, this working may be carried out by spinning or roll forming.

### EMBODIMENT 6

In the embodiment 6, all of pipe-expansion working, curl working and curl precise shaping are carried out by spinning.

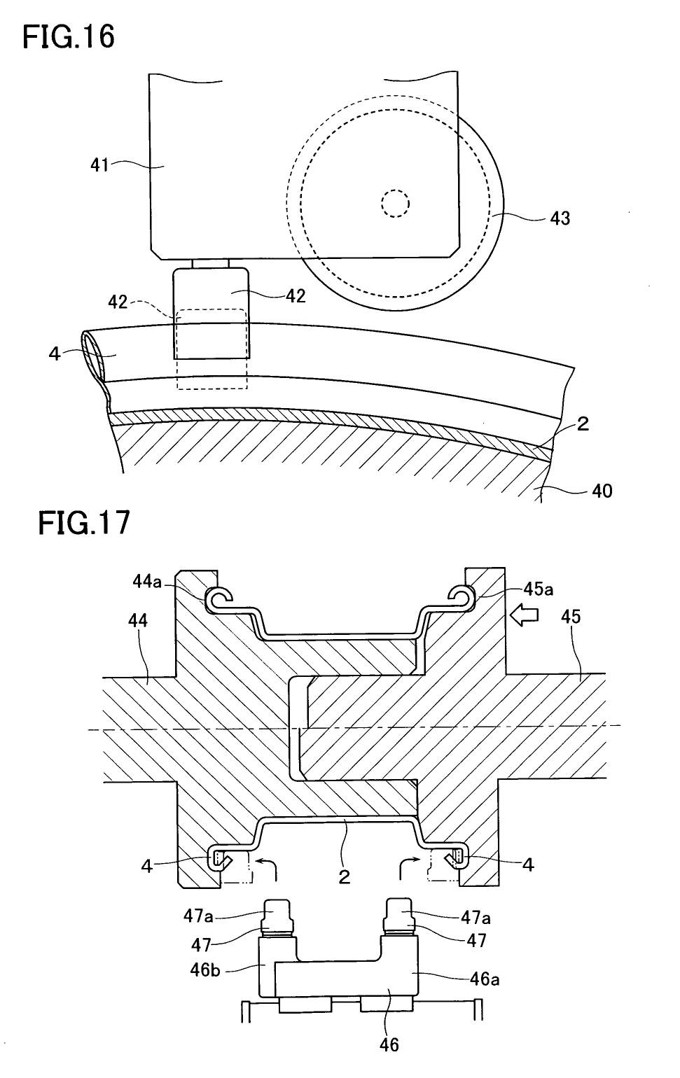

The pipe expansion by spinning is shown in the embodiment 2 (FIG. 7) and the curl working by spinning is shown in the embodiment 4 (FIG. 12). Therefore, they are omitted here. FIGS. 15 and 16 show the curl precise shaping by spinning.

The cylindrical member 2 after the circular cross section curl is formed is mounted to a die 40 attached to the spinning lathe and the cylindrical member 2 is rotated. A side surface of one of oblong dies 42 mounted on a jig 41 pushes a side surface of the base end of each of the curls 4 on the ends of the cylindrical member 2, and the curved side surface is formed into a straight surface.

The jig 41 (holder unit) can move upward, downward, forward, backward, leftward and rightward by means of a hydraulic cylinder or electric motor screw. The jig 41 is provided with the two dies 42 such that they can move vertically and laterally. The dies 42 are disposed at a distance from each other. The jig 41 includes a forming roll 43 fixed to a rear position between the dies 42.

Then, a side surface of the other die 42 pushes the side surface of the tip end of the curl 4 to also form the tip end into a straight surface. Then, the recess 43a of the forming roll 43 pushes a central portion of the arc of the curl 4 to crush the central portion. With this operation, the central portion of the curl 4 is formed into the R-portion having small curvature, and the tip end straight portion is brought into intimate contact with the cylindrical member 2 and is closed. With this, the curl 4 is formed into the a normal shape having a rectangular cross section, in which the R-portion is sandwiched by the straight portions, and the curl 4 is provided with the shape and precision suitable for holding the tire.

The rim 8 obtained in this manner is processed in the same manner as the embodiment 1, and the two-piece wheel is produced.

According to the embodiment 6 also, the same effects as those of the embodiment 1 can be obtained.

Although the curl precise shaping is carried out by spinning in the embodiment 6, this working may be carried out by press or roll forming.

### EMBODIMENT 7

In the embodiment 7, the pipe expansion and drop center portion working are carried out by roll forming simultaneously, and then, curl working is carried out by spinning and curl precise shaping is carried out by roll forming.

Since the concurrent pipe expansion and drop center portion working by roll forming is described in the embodiment 3 (FIG. 11) and curl working by spinning is described in the embodiment 4 (FIG. 12), they are omitted here. FIG. 17 shows curl precise shaping by roll forming.

As shown in FIG. 17, left and right split type dies 44 and 45 which can be fitted into each other in the axial direction and which has recesses 44a and 45a whose bottom surfaces are flat are mounted on the spinning lathe, and the cylindrical member 2 after curl working is mounted on the dies 44 and 45, and are rotated. The die 45 is moved in the axial direction with respect to the die 44 and in this state, diameter-reduced portions 47a and 47a of forming rolls 47 and 47 mounted on a jig 46 push, from laterally inside, side surfaces of tip ends of the curls 4 and 4 received by recesses 44a and 45a of the dies 44 and 45.

The jig 46 can move upward, downward, forward, backward, leftward and rightward by means of a hydraulic cylinder or electric motor screw. One of the forming rolls 47 is fixed to one end of a body 46a of the jig 46, and the other forming roll 47 is mounted on a moving body 46b which can move in the lateral direction with respect to the body 46a.

The base ends of the arcs of the curls 4 and 4 are pressed by the forming rolls 47 and 47 against the recesses 44a and 45a of the dies 44 and 45 and extended straightly, and arc tip ends of the curls 4 and 4 are extended straightly and inwardly inclined, and the tip ends are brought into intimate contact with the cylindrical member 2 and are closed. With this, the curl 4 is formed into a normal shape having a rectangular cross section, in which the R-portion is sandwiched by the straight portions, and the curl 4 is provided with the shape and precision suitable for holding the tire.

The rim 8 obtained in this manner is processed in the same manner as the embodiment 1, and the two-piece wheel is produced.

According to this embodiment, the same effects as those of the embodiment 1 can be obtained.

Although the curl precise shaping is carried out by roll forming working in the embodiment 7, this working may be carried out by press or spinning.

### EMBODIMENT 8

Although both the ends of the cylindrical member are expanded in the above embodiments 1 to 7, the rim is formed without expanding the ends in the embodiment 8. That is, both the ends of the metal cylindrical member are formed into circular cross section curls by plastic working (curl working). Then, the curls are finished to rectangular cross section normal shape curls (normal curls) having the shape and precision suitable for holding the tire (finishing working, i.e., curl precise shaping).

The curl working and finishing working can be carried out by any of press working, spinning working and roll forming working. The cylindrical member is first subjected to the drop center portion working, and the cylindrical member after the drop center portion working is subjected to the curl working. When the curl working is carried out by spinning working or roll forming working, since the drop center portion working can be carried out at the same time, it is unnecessary to carry out the drop center portion working prior to the curl working.

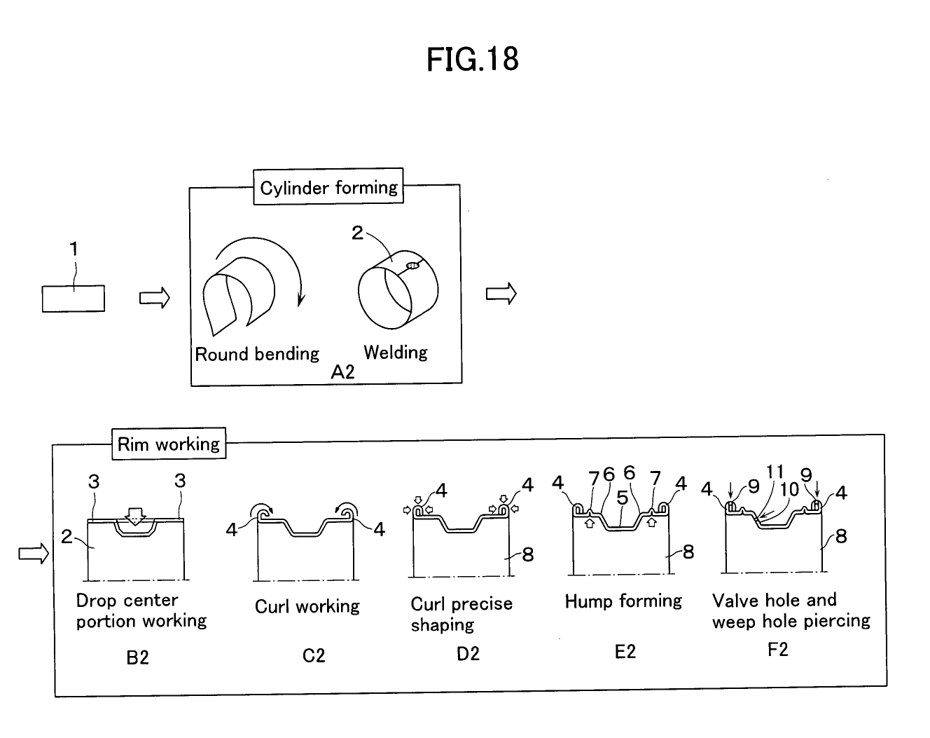

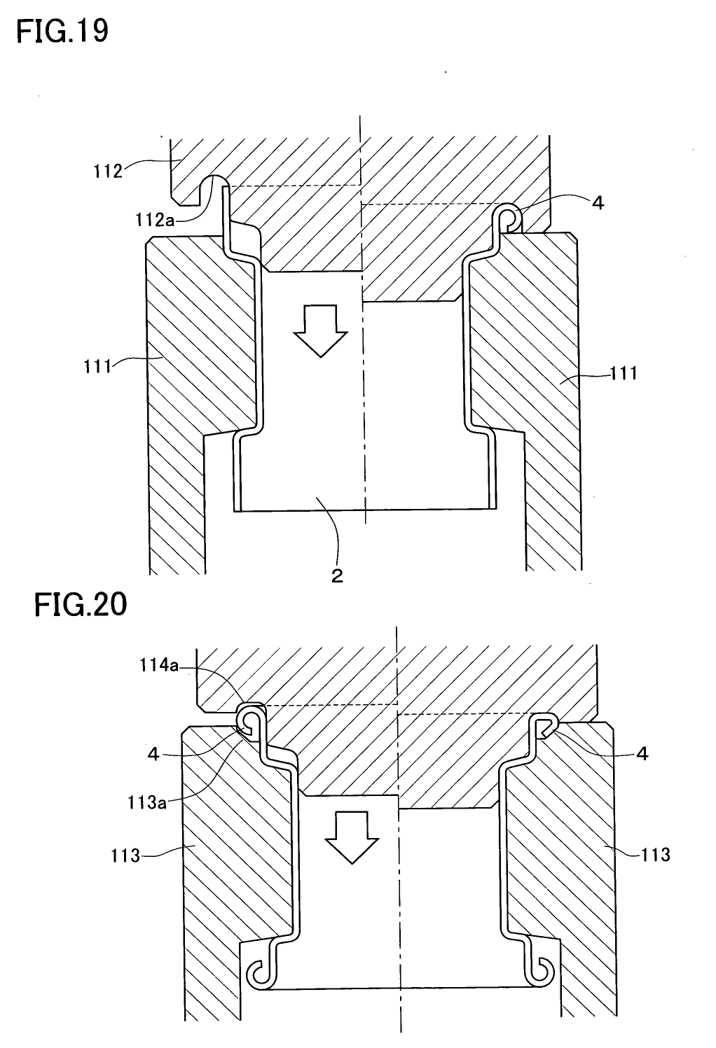

FIG. 18 shows typical working steps in the method for producing a wheel of this embodiment.

First, a prepared blank material 1 which is a metal plate is rounded into a cylindrical shape using a coiler or the like, ends of the rounded blank material 1 along the longitudinal direction are butted against each other and connected to each other by welding to form the cylindrical member 2 (step A2) (which is the same as step A1 in FIG. 1). The drop center portion is formed in the barrel of the cylindrical member 2 by spinning working or roll forming working (step B2). In this step B2, the drop center portion is formed in the barrel of the cylindrical member 2, and a step (not shown) is formed in the barrel so as to make it easy to mount a disk which receives a hub having an axle after the cylindrical member is formed into the rim. After the drop center portion working, the ends 3 of the cylindrical member 2 are inwardly bent to form the circular cross section curls 4 (step C2). Then, the curls 4 are finished into a normal shape having a rectangular cross section provided with the shape and precision suitable for holding the tire (step D2), thereby obtaining the rim 8 provided at both the ends with the rectangular cross section curls 4.

Thereafter, the rim 8 is finished in the same manner as the previous embodiments. That is, the bead sheet portions 6 on both the sides of the drop center portion 5 of the barrel of the rim 8 are provided with humps 7 by spinning working or roll forming working (step E2, which is the same as step H1 in FIG. 1). Then, the weep holes 9 are formed in the curls 4 of the rim 8, the valve hole 11 through which air is charged into a tire which is to be mounted to a wheel is formed in one of the drop inclination portions 10 between the center drop portion 5 and the bead sheet portions 6 on the opposite sides (step F2 which is the same as step I1 in FIG. 1), and the finishing working of the rim 8 is completed. Thereafter, the disk for receiving the axle-mounting hub is mounted in the cylinder of the rim 8 by welding, thereby obtaining the two-piece wheel.

In the embodiment 8, the cylindrical member 2 is subjected to curl working (circular flange portion forming working) by press after the drop center portion working, and the curl precise shaping (finishing working) is carried out by press.

The curl working is carried out as shown in FIG. 19. Left and right split type lower dies 111 and 111, and an upper die 112 having a semi-arc recess 112a are used in the press machine. The cylindrical member 2 after the drop center portion working is mounted in the lower dies 111 and 111. The end 3 of the cylindrical member 2 exposed from upper portions of the lower dies 111 and 111 are pressed by the upper die 112, the end is inwardly bent by the recess 112a, and the end is formed into inwardly rounded circular cross section curl 4.

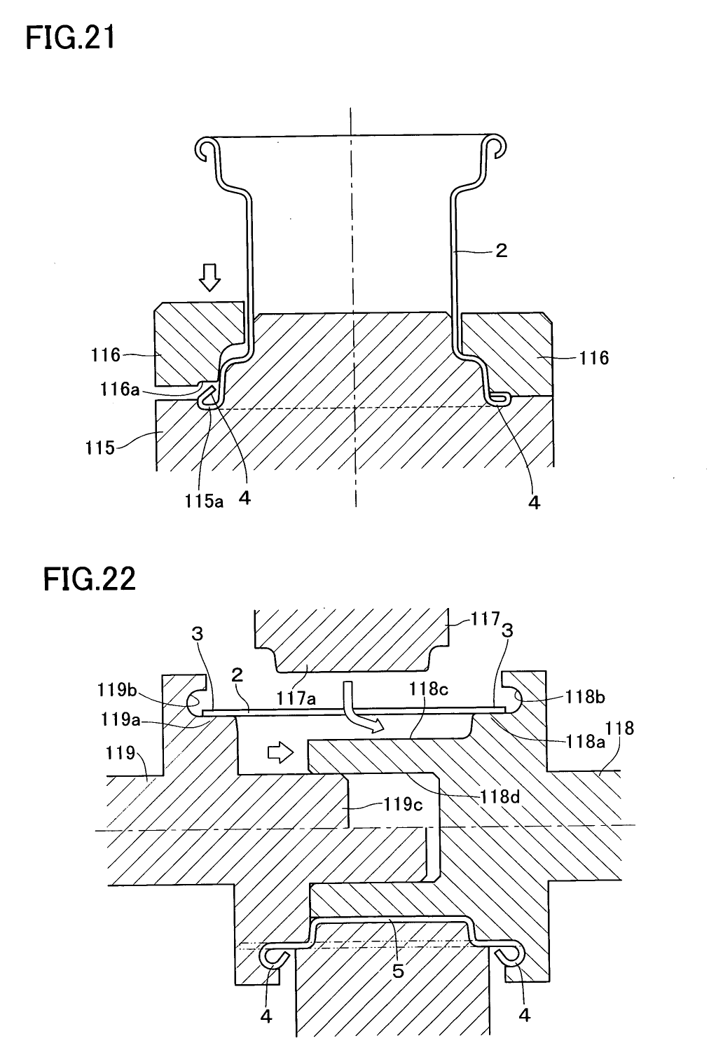

The curl precise shaping is carried out as shown in FIGS. 20 and 21. First, as shown in FIG. 20, using left and right split type lower dies 113 and 113 having notches 113a including tapered surfaces, and an upper die 114 having a shallow recess 114a whose bottom surface is flat, the circular cross section curl 4 of the end of the cylindrical member 2 is pressed, upper surfaces of the arc central portion of the curl 4 is crushed and flattened, and bend of the arc tip end of the curl 4 is straightened and inclined inward by the notches 113a of the tapered surfaces of the lower dies 113.

Then, as shown in FIG. 21, the end is pressed using a lower die 115 having a shallow recess 115a having a flat bottom surface and left and right split type punches 116 and 116 each having a shallow notch 116a having a flat bottom surface. The tip straight portion of each curl 4 is further inwardly inclined by the notch 116a, the curl 4 is brought into intimate contact with the barrel (bead sheet portion) of the cylindrical member 2 and is closed. With this operation, the curl 4 is formed into a normal shape having a rectangular cross section, in which the R-portion is sandwiched by the straight portions, and the curl 4 is provided with the shape and precision suitable for holding the tire.

The bead sheet portions 6 located opposite sides of the drop center portion 5 of the rim 8 which is formed in this manner and provided at both the ends with the inwardly rounded rectangular cross section normal curls 4 are provided with humps 7 by spinning working or roll forming working (step E2). The weep holes 9 are formed in the curls 3 of the rim 8, and a valve hole 11 through which air is charged into a tire which is to be mounted to a wheel is formed in one of the drop inclination portions 10 between the center drop portion 5 and the bead sheet portions 6, and the disk is mounted in the cylinder of the rim 8 by welding, thereby obtaining the two-piece wheel.

The producing method of this embodiment has the above-mentioned configuration, and can exhibit the following effects.

(1) Since a rim both ends of which have rectangular cross section curls can be formed directly from a cylindrical member, it becomes easy to produce a two-piece wheel.

(2) Since a wheel which can be obtained is a two-piece wheel in which a disk is mounted on an inner side of the rim, material can be saved as compared with a conventional wheel in which bottoms of two cups are connected to each other, and it is possible to provide a lightweight wheel.

(3) Since the disk is mounted afterward, the design of the wheel can easily be enhanced by using the disk having excellent design.

(4) Since the rim is formed from the cylindrical member, the alignment of a center axis of the wheel is easy.

(5) Since both the curl working and precise shaping working are carried out by press working, the mass productivity of the wheel is high.

(6) The pipe-expansion step carried out in the embodiments 1 to 7 is unnecessary, and labor in production is saved correspondingly.

Although both the curl working and precise shaping working are carried out by press working in this embodiment 8, the present invention is not limited to this, and the curl precise shaping may be carried out by spinning or roll forming after the curl working by press.

### EMBODIMENT 9

In the embodiment 8, the cylindrical member after the drop center portion working is subjected to curl working and curl precise shaping by press. In the embodiment 9, the curl working and curl precise shaping are carried out by spinning, and the drop center portion working is simultaneously carried out by the spinning at the time of the curl working.

First, curl working and drop center portion working are carried out by spinning at the same time. As shown in FIG. 22, a forming roll 117, and left and right split type dies 118 and 119 which can be fitted into each other in the axial direction are prepared. The right die 118 is mounted on a die supporting section of a spinning lathe, and the left die 119 is mounted on a shaft pushing section of the lathe.

The die 118 includes a step 118a, a semi-arc recess 118b which is continuously formed on a tip end of the step 118a, and a parallel portion 118c which is continuously and downwardly extended from a base end of the step 118a. A cylindrical recess 118d is formed in the axial central portion of the die 118. The die 119 includes a step 119a and a semi-arc recess 119b which is continuously formed on a tip end of the step 119a. The axial central portion of the die 119 is formed as a cylindrical projection 119c which is continuous with a base end of the step 119a. The projection 119c is fitted into the recess 118d of the right die 118. The forming roll 117 is provided at its surface with a parallel projection 117a. The parallel projection 117a is formed into such a shape that is fitted into a parallel recess comprising the step 118a of the die 118, the parallel portion 118c and the step 119a of the die 119 which butts against an end surface of the parallel portion 118c.

One end 3 and the other end 3 of the cylindrical member 2 are mounted on the step 118a of the die 118 and the step 119a of the die 119, and the cylindrical member 2 is rotated by the rotation of the dies 118 and 119. In this state, the die 119 is moved toward the die 118 in the axial direction to shorten a distance between the dies 118 and 119. At the same time, the forming roll 117 is rotated to move the forming roll 117 in the radial direction, and the forming roll 117 is moved toward the die 118 in the axial direction while pushing the barrel of the cylindrical member 2.

With this operation, the one end 3 and the other end 3 of the cylindrical member 2 are pushed by the semi-arc recesses 118b and 119b of the dies 118 and 119, and are bent along the recesses 118b and 119b and are formed into the circular cross section curls 4 and 4. The barrel of the cylindrical member 2 is pushed by the forming roll 117 in the radial direction and narrowed in the axial direction, and is formed into the drop center portion 5.

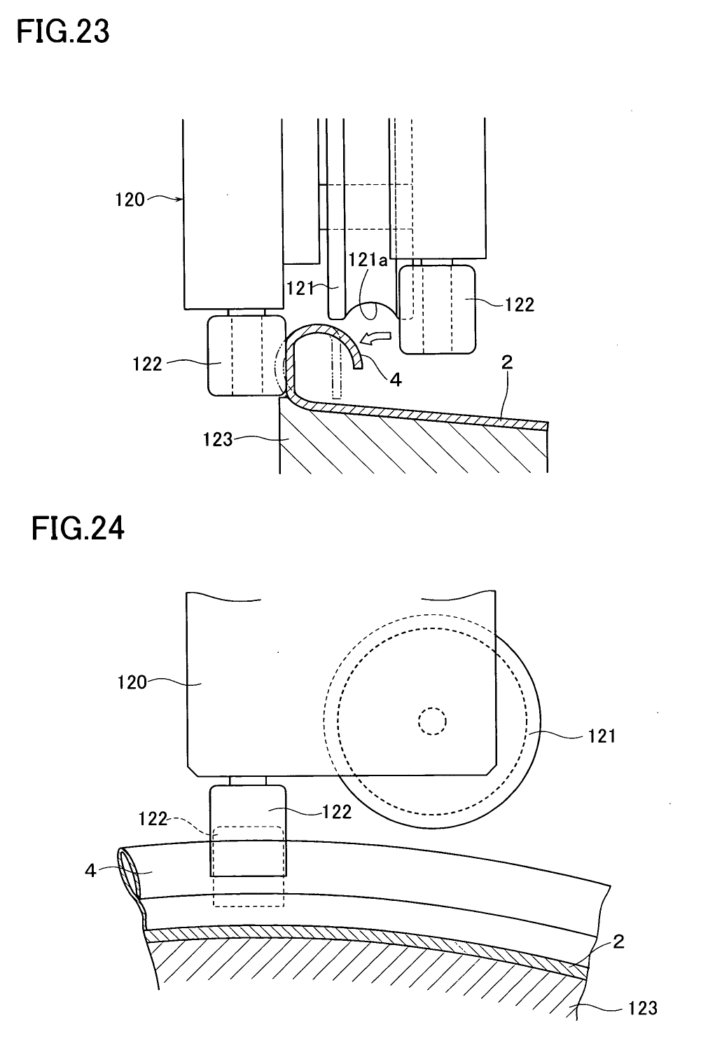

Then, shaping and precision-enhancing working is carried out by spinning. FIGS. 23 and 24 show the working. The cylindrical member 2 after the formation of the circular cross section curls are formed is mounted on a die 123 mounted on the spinning lathe. A side surface of one of oblong dies 122 mounted on a jig 120 is pushed against side surfaces of base ends of the curls 4 on the ends of the cylindrical member 2, and the curved surfaces are formed into straight surfaces.

The jig 120 (holder unit) can move upward, downward, forward, backward, leftward and rightward by means of a hydraulic cylinder or electric motor screw. The jig 120 is provided with the two dies 122 such that they can move vertically and laterally. The dies 122 are disposed at a distance from each other. The jig 120 includes a forming roll 21 fixed to a rear position between the dies 122.

Then, a side surface of the other die 122 pushes the side surface of the tip end of the curl 4 to also form the tip end into a straight surface. Then, the recess 121a of the forming roll 121 pushes a central portion of the arc of the curl 4 to crush the central portion. With this operation, the central portion of the curl 4 is formed into the R-portion having small curvature, and the tip end straight portion is brought into intimate contact with the cylindrical member 2 and is closed. With this, the curl 4 is formed into a normal shape having a rectangular cross section, in which the R-portion is sandwiched by the straight portions, and the curl 4 is provided with the shape and precision suitable for holding the tire.

The rim 8 obtained in this manner is processed in the same manner as the embodiment 8, and the two-piece wheel is produced.

Although the drop center portion working is carried out at the time of curl working, the drop center portion working may be carried out before the curl working.

According to this embodiment also, the same effects as those of the embodiment 8 can be obtained. Especially in this embodiment, both the curl working (drop center portion working) and shaping and precision-enhancing working are carried out by spinning, there is a merit that the embodiment is suitable for producing a small number of and various wheels.

Although the shaping and precision-enhancing working is carried out by spinning in the embodiment 9, the present invention is not limited to this, and the curl precise shaping may be carried out by press or roll forming.

### EMBODIMENT 10

In the embodiment 10, curl working and curl precise shaping are carried out by roll forming, and drop center portion is simultaneously formed by roll forming at the time of the curl working.

The curl working by roll forming is basically the same as curl working by spinning described in the embodiment 8 shown in FIG. 22. In FIG. 22, the embodiment 10 is different from the embodiment 8 in that the forming roll 117 is not moved in the axial direction and is disposed at a position where the forming roll 117 is fitted into the parallel portion 118c of the die 118 from the beginning, and the forming roll 117 is moved only in the radial direction with respect to the cylindrical member 2.

The circular cross section curls 4 are formed on both ends of the cylindrical member 2 by roll forming working using the forming roll 117 which moves as described above and the split type dies 118 and 119 shown in FIG. 22, and the drop center portion 5 is formed in the barrel of the cylindrical member 2.

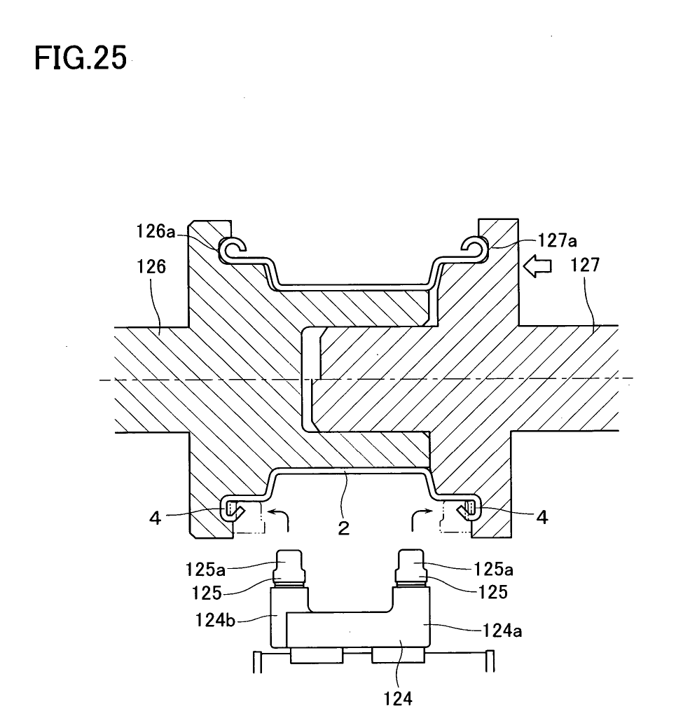

Then, as shown in FIG. 25, the curls 4 are subjected to shaping and precision-enhancing working by roll forming. Left and right split type dies 126 and 127 which have shallow recesses 126a and 127a having flat bottom surfaces and which can be fitted into each other in the axial direction are mounted on a spinning lathe. The cylindrical member 2 after the curls are formed is mounted on the dies 126 and 127 and is rotated. Diameter-reduced portions 125a and 125a of forming rolls 125 and 125 mounted on the jig 124 are pushed, from laterally inward, against side surfaces of tip ends of the curls 4 and 4 received by the recesses 126a and 127a of the dies 126 and 127 while moving the die 127 in the axial direction with respect to the die 126.

The jig 124 can move upward, downward, forward, backward, leftward and rightward by means of a hydraulic cylinder or electric motor screw. One of the forming rolls 125 is fixed to one end of the body 124a of the jig 124, and the other forming roll 125 is mounted on a moving body 124b. The moving body 124b can move laterally with respect to the body 124a.

The arc base ends of the curls 4 and 4 are pressed against the recesses 126a and 127a of the dies 126 and 127 by the forming rolls 125 and 125 and are expanded straightly, the arc tip ends of the curls 4 and 4 are extended straightly and inwardly inclined and are brought into intimate contact with the cylindrical member 2. With this operation, the cross section of each curl 4 is formed into rectangular shape in which the R-portion is sandwiched between the straight portions, and the curl 4 is provided with the shape and precision suitable for holding the tire.

The rim 8 obtained in this manner is processed in the same manner as the embodiment 8, and the two-piece wheel is produced.

According to this embodiment also, the same effects as those of the embodiment 8 can be obtained. Especially in this embodiment, both the curl working (drop center portion working) and shaping and precision-enhancing working are carried out by roll forming, there is a merit that the embodiment is suitable for producing small number of and various wheels.

Although the curl precise shaping is carried out by roll forming working in the embodiment 10, the curl precise shaping may be carried out by press or spinning.

### EMBODIMENT 11

In the embodiment 11, after the drop center portion working, the cylindrical member is subjected to curl working by press, and is subjected to curl precise shaping (finishing working) by spinning. Like the embodiment 8, the curl working by press is carried out as shown in FIG. 19, and the curl precise shaping is carried out by press using spinning as shown in FIGS. 23 and 24 like the embodiment 9.

The rim 8 obtained in this manner is processed in the same manner as the embodiment 8, and the two-piece wheel is produced.

According to this embodiment also, the same effects as those of the embodiment 8 can be obtained.

As apparent from the above explanation, according to the present invention, rectangular cross section curls which are wounded inwardly in the radial direction are formed on both ends of a metal cylindrical member by plastic working, it is possible to easily produce a two-piece wheel having a disk mounted on a rim directly from the cylindrical member. It is possible to reduce material and weight of the wheel, and since a disk having excellent design is mounted, it is possible to easily enhance the design of the wheel. Since the rim is produced from the cylindrical member, it is easy to center a center shaft of the wheel.

1. A two-piece wheel comprising a rim having flange portions having rectangular cross sections formed by doubly bending both ends of a metal cylindrical member in a radial direction of the cylindrical member by plastic working, and
a disk disposed in the rim perpendicularly to an axis of the rim and having a peripheral edge connected to an inner wall of the rim.

2. A method for producing a two-piece wheel in which a disk is disposed in a rim perpendicularly to an axis of the rim and a peripheral edge of the disk is connected to an inner wall of the rim, the method comprising:
a pipe-expansion step for expanding both ends of a cylindrical metal rim material by plastic working, and
a rectangular flange portion-forming step for deforming the expanded ends by plastic working and forming flange portions having rectangular cross sections which are doubly bent in a radial direction.

3. The method according to claim 2, wherein the pipe-expansion step is carried out by press working, spinning working or roll forming working.

4. The method according to claim 2 or 3, wherein the rectangular flange portion-forming step is carried out by press working or spinning working.

5. A method for producing a two-piece wheel in which a disk is disposed in a rim perpendicularly to an axis of the rim and a peripheral edge of the disk is connected to an inner wall of the rim, the method comprising:
a pipe-expansion step for expanding both ends of a cylindrical metal rim material by plastic working,
a circular flange portion-forming step for forming the expanded ends into flange portions having circular cross sections in the radial direction by plastic working, and
a finishing step for deforming the flange portions having circular cross sections into the flange portions having rectangular cross sections which are doubly bent in the radial direction by plastic working.

6. The method according to claim 5, wherein pipe-expansion step is carried out by press working, spinning working or roll forming working.

7. The method according to claim 5 or 6, wherein the circular flange portion-forming step is carried out by spinning working.

8. (Currently Amended) The method according to claim 5 or 6, wherein the finishing step is carried out by press working, spinning working or roll forming.

9. A method for producing a two-piece wheel in which a disk is disposed in a rim perpendicularly to an axis of the rim and a peripheral edge of the disk is connected to an inner wall of the rim, the method comprising:
a circular flange portion-forming step for forming both ends of a cylindrical metal rim material into flange portions having circular cross sections in a radial direction by plastic working, and
a finishing step for deforming the flange portions having circular cross sections into the flange portions having rectangular cross sections which are doubly bent in the radial direction by plastic working.

10. The method according to claim 9, wherein the circular flange portion-forming step is carried out by press working, spinning working or roll forming working.

11. The method according to claim 9 or 10, wherein the finishing step is carried out by press working, spinning working or roll forming working.
